(19) United States
(12) Patent Application Publication
(10) Pub. No.: US 2008/0294557 A1
(43) Pub. Date: Nov. 27, 2008

(54) Data Processing System And Method

(76) Inventors: Srinivasan RAMANI, Bangalore (IN); Anil Kumar, Bangalore (IN); Darpan Goel, Bangalore (IN); Johann Terrier, Sauverny (CH)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/107,087

(22) Filed: Apr. 22, 2008

(30) Foreign Application Priority Data
May 25, 2007 (IN) 1092/CHE/2007

(51) Int. Cl. G06Q 40/00

(52) U.S. Cl. 705/44

(57) ABSTRACT

A method of authenticating a transaction, comprising providing details of a card to a merchant; providing transaction identifying information to a data processing device; and sending the transaction identifying information to a third party using the data processing device.

### RELATED APPLICATIONS

Benefit is claimed under 35 U.S.C. 119(a)-(d) to Foreign application Ser. 1092/CHE/2007 entitled “DATA PROCESSING SYSTEM AND METHOD” by Hewlett-Packard Development Company, L.P., filed on 25 May, 2007, which is herein incorporated in its entirety by reference for all purposes.

### BACKGROUND OF THE INVENTION

Credit cards, debit cards, charge cards and other cards can be used to make transactions (for example, the purchase of goods or services) at retail premises, and also over the internet and telephone. However, the card being used may be misused by a person who acquires some or all of the details of the card.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a known system for carrying out a transaction;

FIG. 2 shows an example of a system for authenticating a transaction according to embodiments of the invention; and

FIG. 3 shows an example of a mobile device according to embodiments of the invention.

### DETAILED DESCRIPTION OF EMBODIMENTS OF THE INVENTION

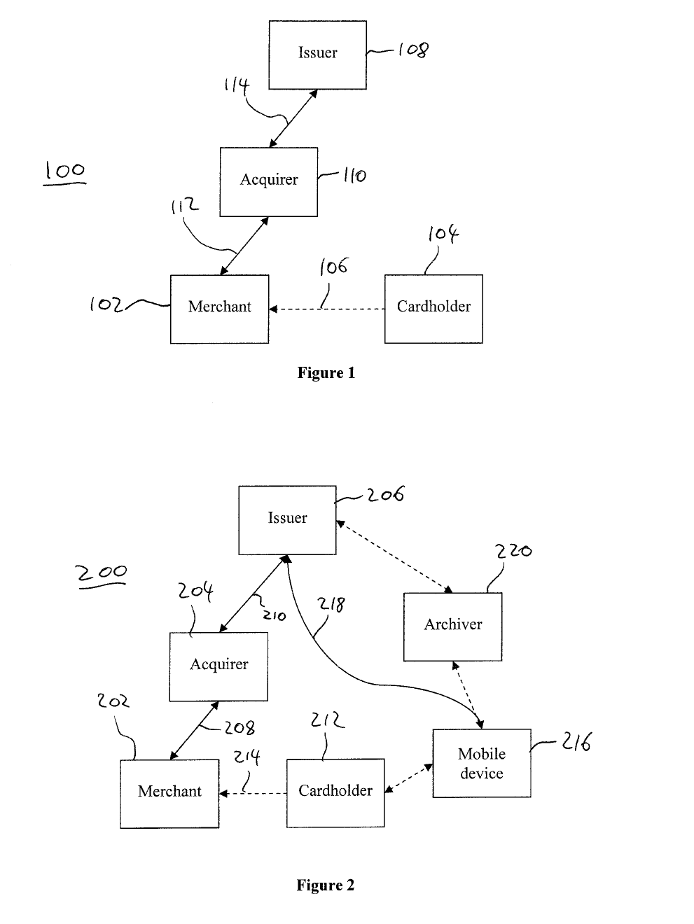

The system 100 of FIG. 1 includes a merchant 102 to which a cardholder 104 gives card details as indicated by arrow 106. The cardholder is issued the card (for example, a credit card, debit card, charge card or other card) by a card issuer 108. The card details may include, for example, one or more of the PAN (Personal Account Number, which may be the number printed on the front of the card), PIN (Personal Identification Number), expiration date, start date, issue number and/or other details. In certain cases, where the PAN is different from the card number (CN) on the front of the card, the PAN and/or the CN may be included in the card details. Where the merchant 102 is a retail premises at which the cardholder 104 is present, the merchant 102 may acquire the card details by, for example, swiping the card through a magnetic stripe reader, copying the details from the information printed on the card and/or asking the cardholder 104 to input the details. Where the transaction is to be made by the cardholder using the internet or telephone, the card details may be provided to the merchant 102 over the internet or telephone as appropriate.

Once the merchant 102 has obtained the appropriate card details, the merchant sends merchant transaction information to the acquirer 110. The merchant transaction information comprises the card details along with the Merchant ID (MID) and the amount of the transaction (the purchase amount, or Value of Transaction VoT). The MID is a unique ID given to the merchant by, for example, the acquirer 110 or the issuer 108. The merchant ID sends this information to the acquirer 110 using a communications link 112. Typically, the communications link 112 will be a dial-up connection for small merchants and a leased line for larger merchants, although any type of communications link may be used. A communications standard, such as, for example, ANSI X9.2, may be used to communicate the information using the communications link 112. The information sent to the acquirer 110 comprises the transaction request.

The acquirer 110 may perform initial screening of the transaction request. For example, the acquirer may filter out transaction requests that contain an invalid Merchant ID, a known bad (for example, stolen) PAN, an out of date expiration date and/or other information. The filters used by the acquirer 110 to filter the transaction requests may be provided or indicated by the issuer 108. The acquirer may also be authorized to approve certain transaction requests and send approval back to the merchant 102. In the case where a transaction request is filtered out or is approved by the acquirer 110, the acquirer 110 may provide details of the transaction request to the issuer 108 immediately or later.

Where the transaction request is not filtered out or approved by the acquirer 110, the acquirer 110 sends details of the transaction request (for example, forwards the transaction request) to the card issuer 108 using a communications link 114. The communications link 114 may be, for example, a leased line, although any other type of communications link may be used. A standard such as ANSI X9.2 may be used over the communications link 114, although other forms of communication may alternatively be used.

The card issuer 108 may perform some or all of the same filtering performed by the acquirer 110. Additionally, the issuer 108 is able to verify the PIN (where it is included within the transaction request) and look up the cardholder's account with the issuer to verify that the cardholder has sufficient funds to make the transaction. The issuer 108 may send a transaction refusal back to the merchant 102 if the transaction request does not meet the requirements of the issuer 108 (for example, the cardholder does not have sufficient funds or the PIN is incorrect). Otherwise, the issuer 108 sends an approval back to the merchant 102.

Where the merchant 102 receives an approval for the transaction request, the transaction is complete, and the merchant 102 may then provide the requested goods and/or services to the cardholder 104.

In certain cases, the card issuer 108 is also an acquirer.

FIG. 2 shows a system 200 for authenticating a transaction according to embodiments of the invention. The system 200 includes a merchant 202, an acquirer 204 and an issuer 206 that are similar to those found in FIG. 1. In particular, the merchant 202 and acquirer 204 do not require any additional functionality over those shown in FIG. 1 to be used with embodiments of the invention. Furthermore, even if other paties, such as, for example, the issuer 206 require additional functionality, the additional functionality may be added, for example, with little or no changes to the existing infrastructure for carrying out transactions. Therefore, embodiments of the invention may be easily deployed and used with existing systems for carrying out a transaction. A communication link 208 exists between the merchant 202 and the acquirer 204 (such as, for example, a dial-up connection or a leased line). A communication link 210 exists between the acquirer 204 and the issuer 206 (for example, a leased line).

When a cardholder 212 wishes to make a transaction, the cardholder provides card details to the merchant 202, as indicated by the arrow 214, in a manner similar to that described above in reference to FIG. 1. So, for example, the cardholder 212 may be present at the premises of the merchant 202 or may provide the card details to the merchant 202 over the internet or telephone. The cardholder 212 also provides transaction identifying information to a mobile device 216. The transaction identifying information will be used by the issuer 206 to authenticate the transaction as indicated in further detail below. However, the issuer 206 will receive sufficient information from the merchant 202, in the form of merchant transaction information, to complete the transaction. Therefore, the information supplied to the issuer 206 must only be sufficient for the issuer 206 to match the transaction being identified with merchant transaction information received from the merchant 202, although more information may be included if desired.

In embodiments of the invention, the cardholder enters the Merchant ID (MID) and the Value of the Transaction (VoT) into the mobile device 216 using a device input on the mobile device 214. The MID may, for example, be displayed at the merchant's premises or may be provided on a merchant's web site or over the telephone, or may be provided in some other way. In alternative embodiments of the invention, the MID and/or the VoT may be provided to the mobile device 216 in other ways, such as, for example, within a text message, RFID communication, Bluetooth communication or other communication sent to the mobile device by the merchant 202.

The mobile device 216 also stores a shared secret string (SSS) and one or both of the card number (CN) and Personal Account Number (PAN). These details may, for example, be provided to the mobile device 216 before the transaction is commenced. The shared secret string (SSS) is issued by the issuer 206 to the cardholder 212, for example using postage, or is supplied to the mobile device 216. Thus, the SSS is known to the mobile device 216 and the issuer 206. The issuer may take adequate care to ensure that the SSS of different card holders is always safely handled during storage, transmission and use. It may be securely stored, transmitted and used, using encryption where necessary, so that SSS is known only to the data processing systems that need to use it and not, for example, to staff of the issuer 206. The mobile device 216 may, in certain embodiments, store (with adequate safeguards, if required or desired) the PAN and/or CN of multiple cards issued to the cardholder 212, and the cardholder 212 may select the card being used in the transaction to indicate to the mobile device 216 the correct CN/PAN.

In embodiments of the invention, the transaction identifying information comprises the CN and/or PAN, MID and VoT. Once the MID and VoT have been entered into the mobile device 216, the mobile device uses a hash function (for example, SHA, MD5 or other hash function) to compute a hash function value of the transaction identifying information and the shared secret string SSS. The transaction identifying information and the hash function value are then sent to the issuer 206 as indicated by the arrow 218. In alternative embodiments of the invention, the transaction identifying information is also sent to an archiver 220 that records the transaction identifying information for record keeping purposes; this information could be used, for example, to settle any dispute between the card holder and the issuer regarding commitments the card holder has made.

The transaction identifying information may be sent by the mobile device 216 to both the issuer 206 and the archiver 220, or may be sent to the issuer 206 via the archiver 220. The transaction identifying information may be sent to the issuer 206 in parallel to the merchant transaction information sent to the issuer 206 and/or the acquirer 204 by the merchant 202.

Once the issuer 206 has received the transaction identifying information from the mobile device 216, the issuer 206 computes the hash function value of the transaction identifying information and the shared secret string SSS. The shared secret string SSS was not included within any communication sent from the mobile device 216 to the issuer 206, and therefore the SSS cannot be recovered from any such communication, and any such communication cannot be forged by another person. The issuer 206 then checks that the hash function value is identical to that included received from the mobile device 216. If the hash function values do not match, then the issuer 206 sends a transaction refusal to the merchant 202. The issuer 206 may also send a communication to the mobile device 216 indicating that the transaction has been refused, and the mobile device 216 may indicate to the cardholder 212 that the transaction has been refused, for example by providing an indication on a display device associated with the mobile device 216.

If the hash function values match, then the issuer 206 searches merchant transaction information previously received by the issuer 206 for merchant transaction information with the same CN and/or PAN, MID and VoT as the transaction identifying information. If matching information is found, then the issuer 206 may send a transaction approval to the merchant 202. However, the issuer 206 may still send a transaction refusal to the merchant 202 in the event of, for example, insufficient funds of the cardholder 212 and/or an incorrect PIN (if any) supplied within the merchant transaction information. The issuer 206 may not wait for a communication from the mobile device 216 when sending a transaction refusal to the merchant 202.

If the issuer cannot find matching merchant transaction information, then the issuer 206 waits until matching transaction information is received from the merchant 202. In embodiments of the invention, the transaction identifying information expires after a certain time if matching merchant transaction information is not received.

If matching merchant transaction information is received from the merchant 202, then the issuer 206 may send a transaction approval or refusal to the merchant 202 as appropriate.

In alternative embodiments of the invention, the acquirer may operate in a manner similar to that described above in respect of the issuer, either in place of or in addition to the issuer. Therefore, in embodiments of the invention, the issuer and/or the acquirer comprise a third party with which the cardholder (or the cardholder's mobile device) authenticates the transaction.

The mobile device 216 may comprise any device that the user can carry and that can communicate with the issuer 206 and/or the acquirer 204, and/or the archiver 220 where necessary. For example, the mobile device may comprise a mobile phone, cell phone, PDA, laptop and/or other mobile device. The mobile device may communicate with the issuer 206, acquirer 204 and/or archiver 220 using any form of wired and/or wireless communication such as, for example, Wi-Fi, WiMAX, GSM, 3G, Bluetooth and/or other form of communication. Embodiments of the invention are not limited to the methods by which the mobile device 216 can communicate and/or the methods by which the issuer 206, acquirer 204, merchant 202, archiver 220 (if any) and the cardholder 212 communicate.

In alternative embodiments of the invention, a data processing device may be used in place of the mobile device. A data processing device is any device that is capable of the functionality described above in respect of the mobile device. For example, a personal computer (PC) may be used in place of the mobile device. Such as data processing device may be used, for example, in embodiments of the invention in particular where the cardholder communicates with the merchant using the internet or a telephone. However, the data processing device may be a mobile device such as, for example, those described above.

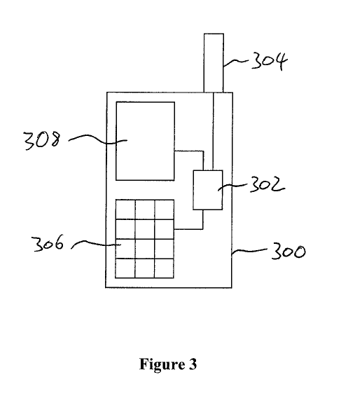

FIG. 3 shows an example of a mobile device 300, suitable for use with embodiments of the invention, which comprises a mobile phone. The device 300 includes one or more data processors 302 for sending and receiving communications using an internal or external antenna 304. The device 300 also includes a device input, comprising a keypad 306, and a display device 308.

In certain embodiments of the invention, the mobile device is protected by a password or PIN (which may be the same as or different to the PIN associated with a card) which must be entered in order to activate and/or use the mobile device. Therefore, the mobile device cannot be used by individuals other than the cardholder to send communications to the card issuer.

In embodiments of the invention, existing mobile devices can be modified to enable functionality according to embodiments of the invention. For example, one or more applications can be installed on a mobile telephone such that it can function as the mobile device in embodiments of the invention.

In embodiments of the invention where a communication is sent from the mobile device to the card issuer using at least one link using SMS communications, one or more HP Wireless Application Messaging Servers (WAMS) could be used to receive and/or process the SMS messages accordingly.

In embodiments of the invention, communications from the mobile device to the issuer may be sent over unencrypted links as the communication cannot be forged by virtue of the hash function value, which is based on information including the shared secret string (SSS). However, the communication links may be encrypted if desired. If encrypted links are used, in embodiments of the invention the shared secret string (SSS) may be omitted.

Embodiments of the invention may contribute to reducing card fraud as a stolen card or stolen card details cannot be used without also using the mobile device to send information to the issuer 206.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of authenticating a transaction, comprising:
providing details of a card to a merchant;
providing transaction identifying information to a data processing device; and
sending the transaction identifying information to a third party using the data processing device.

2. A method as claimed in claim 1, comprising the merchant sending a transaction request to the third party in parallel with the transaction identifying information.

3. A method as claimed in claim 1, wherein the transaction identifying information comprises at least one of a Merchant ID, a value of the transaction, a Personal Account Number and a Card Number.

4. A method as claimed in claim 1, comprising determining a hash function value of the transaction identifying information and a secret string, and sending the hash function value to the third party.

5. A method as claimed in claim 4, wherein sending the hash function value comprises sending the hash function value with the transaction identifying information to the third party.

6. A method as claimed in claim 1, comprising the third party comparing the transaction identifying information with merchant transaction information sent by the merchant to the third party due to the transaction.

7. A method as claimed in claim 6, comprising the third party sending a transaction approval or a transaction refusal to the merchant based on the comparing.

8. A method as claimed in claim 1, wherein the third party comprises at least one of an issuer and an acquirer.

9. A data processing device for authorizing a transaction, arranged to receive transaction identifying information from a user, and send the transaction identifying information to a third party to authorize the transaction.

10. A data processing device as claimed in claim 9, arranged to determine a hash function value of the transaction identifying information and a secret string, and send the hash function value to the third party.

11. A data processing device as claimed in claim 10, arranged to send the hash function value along with the transaction identifying information to the third party.

12. A system for authenticating a transaction, comprising:
a data processing device arranged to receive transaction identifying information from a device input, and send the transaction identifying information to a third party to authorize the transaction.

13. A system for implementing the method as claimed in claim 1.

14. A method of authenticating a transaction, comprising:
receiving transaction identifying information; and
sending the transaction identifying information to a third party to authorize the transaction.

15. A computer program for implementing the method as claimed in any of claims 1 and 14.

16. Computer readable storage storing a computer program as claimed in claim 15.
